(19) United States
(12) Patent Application Publication
(10) Pub. No.: US 2022/0021954 A1
(43) Pub. Date: Jan. 20, 2022

(54) INFORMATION COLLECTION SYSTEM AND METHOD

(71) Applicant: Hitachi, Ltd., Tokyo (JP)

(72) Inventors: Keisuke UCHIGATA, Tokyo (JP); Kousuke SHIBATA, Tokyo (JP); Shotaro TANAKA, Tokyo (JP); Takashi TAKAGI, Tokyo (JP)

(73) Assignee: Hitachi, Ltd.

(21) Appl. No.: 17/207,147

(22) Filed: Mar. 19, 2021

(30) Foreign Application Priority Data
Jul. 16, 2020 (JP) 2020-122201

(51) Int. Cl. H04Q 9/00; G01M 3/24

(52) U.S. Cl. CPC H04Q 9/00; G16Y 40/10; G01M 3/243

(57) ABSTRACT

Proposed is an information collection system and method capable of reliably collecting information even from sensors installed at locations where a vehicle cannot pass through, and also promptly collecting information of urgent nature. Each sensor not positioned on a route travelled by a travel vehicle transmits, to sensors of a subsequent stage in multihop wireless communication preset so that information is aggregated in a predetermined sensor positioned on the route travelled by the travel vehicle, information transmitted from sensors of a preceding stage in the multihop wireless communication, as well as its own information, and the sensor positioned on the route travelled by the travel vehicle transmits the aggregated information to a receiver. Moreover, during an abnormal condition where an abnormality is detected in an abnormal value determination, each sensor not positioned on the route travelled by the travel vehicle switches a transmission destination of the information to one of the sensors in a multihop network which aggregates information in the sensor positioned on the route having a higher travel frequency of the travel vehicle than the route on which the sensor of an aggregation destination of information is positioned during a normal condition.

### TECHNICAL FIELD

The present invention relates to an information collection system and method, and can be suitably applied, for example, to a water leakage monitoring system which monitors water leakage of a water pipe.

### BACKGROUND ART

Conventionally, various types of monitoring systems for constantly monitoring the condition of structures with high precision based on post-installation of IoT (Internet of Things) sensors have been put into practical application, and as one such example there is a water leakage monitoring system which monitors the existence of water leakage of a water pipe. With a water leakage monitoring system, a plurality of water leakage sensors, which are configured from IoT sensors, are installed on a water pipe at given intervals, and water leakage of the water pipe is detected based on the output of such water leakage sensors.

With this kind of water leakage monitoring system, since numerous water leakage sensors are installed across a broad range, for instance, if a SIM (Subscriber Identity Module) is installed in all of these water leakage sensors and the output of each water leakage sensor is to be collected via LTE (Long Term Evolution) communication, the communication cost will increase. Thus, currently, a maintenance worker drives a vehicle equipped with a receiver along the road above the water leakage sensors and collects the sensor data from each water leakage sensor via short-distance wireless communication based on Bluetooth (registered trademark) technology or the like.

Note that, as a water leakage detection system of a water pipe, for instance, PTL 1 discloses a water leakage detection system in which a sensor terminal is configured so that it converts a measurement signal including frequency components into data according to a frequency resolution based on a measurement condition received from an operation part and transmits the converted data to the operation part, and, when the operation part determines that there is water leakage based on the received data, the operation part transmits to each sensor terminal a measurement condition of reducing the frequency resolution of data. According to this water leakage detection system, there is an advantage in that high reliability can be obtained even when the amount of communicable data is limited.

Moreover, PTL 2 discloses a water leakage detection system which acquires time synchronization between water leakage detection terminals disposed adjacent to each other based on vibration data which differs from the vibration data of water leakage included in the vibration data detected by the water leakage detection terminal.

### CITATION LIST

### Patent Literature

[PTL 1] Japanese Unexamined Patent Application Publication No. 2019-207113

[PTL 2] Japanese Unexamined Patent Application Publication No. 2019-95292

### SUMMARY OF THE INVENTION

### Problems to be Solved by the Invention

Nevertheless, according to the existing sensor data collection methods described above, there was a problem in that it is not possible to collect the sensor data of water leakage sensors installed at locations where a vehicle cannot pass through.

The present invention was devised in view of the foregoing points, and an object of this invention is to propose an information collection system and method capable of reliably collecting information even from sensors installed at locations where a vehicle cannot pass through, and also promptly collecting information of urgent nature.

### Means to Solve the Problems

In order to achieve the foregoing object, the present invention provides an information collection system, comprising: a plurality of sensors installed in a structure, wherewith each of the plurality of sensors sequentially transmits sensor data and/or an abnormal value determination result of the sensor data based on a multihop wireless communication method; and a receiver, which is mounted on a travel vehicle that travels along a given route, which receives the sensor data transmitted from the sensors positioned on the route, wherein: each of the sensors not positioned on the route travelled by the travel vehicle transmits, to the sensors of a subsequent stage in multihop wireless communication preset so that the sensor data and/or the abnormal value determination result is aggregated in a predetermined sensor positioned on the route travelled by the travel vehicle, the sensor data and/or the abnormal value determination result transmitted from the sensors of a preceding stage in the multihop wireless communication, as well as its own sensor data and abnormal value determination result; the sensor positioned on the route travelled by the travel vehicle transmits the aggregated sensor data and/or abnormal value determination result to the receiver; and during an abnormal condition where an abnormality is detected in the abnormal value determination, each of the sensors not positioned on the route travelled by the travel vehicle switches a transmission destination of the sensor data and/or the abnormal value determination result to one of the sensors in a multihop network which aggregates the sensor data and/or the abnormal value determination result in the sensor positioned on the route having a higher travel frequency of the travel vehicle than the route on which the sensor of an aggregation destination of the sensor data and/or the abnormal value determination result is positioned during a normal condition where an abnormality is not detected in the abnormal value determination.

The present invention additionally provides an information collection method to be executed in an information collection system which collects sensor data and/or an abnormal value determination result of the sensor data from a plurality of sensors installed in a structure, wherein: the information collection system includes a receiver, which is mounted on a travel vehicle that travels along a given route, which receives the sensor data transmitted from the sensors positioned on the route; the information collection method comprises; a first step of each of the sensors not positioned on the route travelled by the travel vehicle transmitting, to the sensors of a subsequent stage in multihop wireless communication preset so that the sensor data and/or the abnormal value determination result is aggregated in a predetermined sensor positioned on the route travelled by the travel vehicle, the sensor data and/or the abnormal value determination result transmitted from the sensors of a preceding stage in the multihop wireless communication, as well as its own sensor data and abnormal value determination result; and a second step of the sensor positioned on the route travelled by the travel vehicle transmitting the aggregated sensor data and/or abnormal value determination result to the receiver; and, in the first step, during an abnormal condition where an abnormality is detected in the abnormal value determination, each of the sensors not positioned on the route travelled by the travel vehicle switches a transmission destination of the sensor data and/or the abnormal value determination result to one of the sensors in a multihop network which aggregates the sensor data and/or the abnormal value determination result in the sensor positioned on the route having a higher travel frequency of the travel vehicle than the route on which the sensor of an aggregation destination of the sensor data and/or the abnormal value determination result is positioned during a normal condition where an abnormality is not detected in the abnormal value determination.

According to the information collection system and method of the present invention, since the sensor data and/or the abnormal value determination result of sensors not positioned on the travel route of the travel vehicle is aggregated in a sensor positioned on the travel route of the travel vehicle, the sensor data and/or the abnormal value determination result can be collected with the receiver mounted on the travel vehicle. In addition, according to the information collection system and method of the present invention, when a sensor not positioned on the travel route of the travel vehicle detects an abnormality in the abnormal value determination, such abnormal value determination result can also be collected promptly.

### Advantageous Effects of the Invention

According to the present invention, it is possible to realize an information collection system and method capable of reliably collecting information even from sensors installed at locations where a vehicle cannot pass through, and also promptly collecting information of urgent nature.

### BRIEF DESCRIPTION OF DRAWINGS

FIG. 1 is a block diagram showing the overall configuration of the water leakage monitoring system according to this embodiment.

FIG. 2 is a block diagram showing the configuration of the water leakage sensor.

FIG. 3 is a conceptual diagram for explaining the sensor data, etc. collection method according to this embodiment.

FIG. 4 is a conceptual diagram for explaining the sensor data, etc. collection method according to this embodiment.

FIG. 5 is a conceptual diagram for explaining the sensor data, etc. collection method according to this embodiment.

FIG. 6 is a diagram showing a configuration example of the sensor data table.

FIG. 7 is a diagram showing a configuration example of the routing table.

FIG. 8 is a diagram showing a configuration example of the activation command target sensor table.

FIG. 9 is a flowchart showing the processing routine of the multihop data transmission processing.

FIG. 10 is a flowchart showing the processing routine of the water leakage sensor activation processing.

### BRIEF DESCRIPTION OF DRAWINGS

An embodiment of the present invention is now explained in detail with reference to the appended drawings.

### (1) Configuration of Water Leakage Monitoring System According to This Embodiment

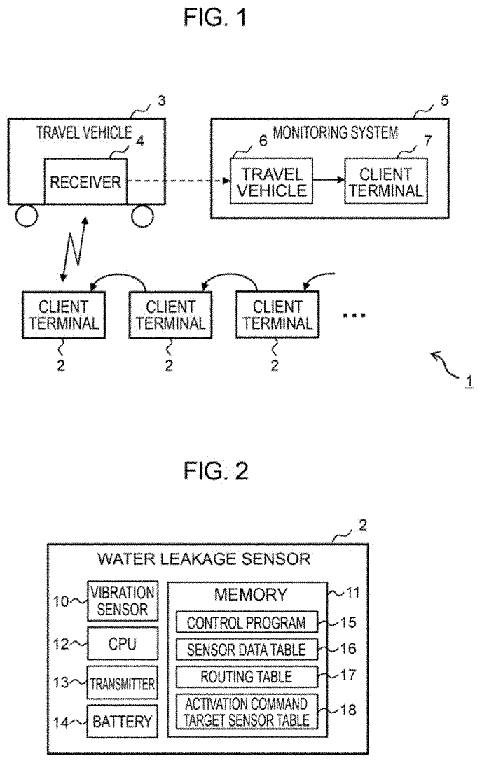

In FIG. 1, reference numeral 1 shows the overall water leakage monitoring system according to this embodiment. The water leakage monitoring system 1 is a system for monitoring the water leakage of a water pipe embedded in the ground, and is configured by comprising a plurality of water leakage sensors 2 installed on the water pipe at given intervals, a receiver 4 mounted on a travel vehicle 3, and a monitoring system 5.

The water leakage sensor 2 is a sensor for detecting the water leakage of the water pipe on which it is installed, and is configured by comprising, as shown in FIG. 2, a vibration sensor 10, a memory 11, a CPU (Central Processing Unit) 12 and a transmitter 13, and a battery 14 for supplying drive power to the vibration sensor 10, the memory 11, the CPU 12 and the transmitter 13.

The vibration sensor 10 is a sensor element which detects a vibration associated with the water leakage of the water pipe on which it it installed, and outputs sensor data of a digital value according to the detected vibration. The memory 11 is configured, for example, from a semiconductor memory, and is used as a work memory of the CPU 12. A control program 15, a sensor data table 16, a routing table 17 and an activation command target sensor table 18 (all described later) are also stored and retained in the memory 11.

The CPU 12 is a processor with functions of performing abnormal value determination, which is the determination of whether the sensor data output from the vibration sensor 10 is an abnormal value, based on the control program 15 stored in the memory 11, and, as described later, transmitting, to the water leakage sensor 2 of a subsequent stage in multihop wireless communication, sensor data and a determination result of the abnormal value determination of such sensor data (this is hereinafter referred to as the “abnormal value determination result”) transmitted from the water leakage sensor 2 of a preceding stage in the multihop wireless communication, as well as its own sensor data and abnormal value determination result.

The transmitter 13 is a communication unit with a function of communicating with the transmitter 13 of another water leakage sensor 2 based on a multihop wireless communication method. Moreover, in addition to the foregoing multihop wireless communication function, the transmitter 13 of the water leakage sensor 2 positioned on the travel route of the travel vehicle 3 is also equipped with a communication function of performing short-distance wireless communication (via Bluetooth or the like) with the receiver 4 mounted on the travel vehicle 3, and transmitting the sensor data and its abnormal value determination result (these are hereinafter collectively referred to as the “sensor data, etc.”) of another water leakage sensor 2 that it has aggregated, as well as its own sensor data, etc., to the receiver 4.

Here, the expression “water leakage sensor positioned on the travel route of the travel vehicle” is referring to a water leakage sensor 2 positioned in a range communicable with the receiver 4 mounted on the travel vehicle 3 that is traveling along the travel route, and does not necessarily means a water leakage sensor 2 that is embedded immediately below the travel route.

The receiver 4 is a reception unit with a function of communicating with the water leakage sensor 2 positioned on the travel route of the travel vehicle 3 on which it is mounted based on a short-distance wireless communication method. The receiver 4 transmits, to the monitoring system 5, the sensor data, etc. of each water leakage sensor 2 from these water leakage sensors 2.

The monitoring system 5 is configured from a water leakage monitoring server 6 and a client terminal 7. The water leakage monitoring server 6 is a general-purpose server device comprising information processing resources such as a CPU, a memory and a hard disk device. The water leakage monitoring server 6 determines whether there is any water leakage based on the sensor data, etc. of each water leakage sensor 2 transmitted from the receiver 4, and generates screen data of a predetermined water leakage monitoring screen displaying the result of the foregoing determination and the data value of the sensor data of each water leakage sensor 2. The water leakage monitoring server 6 thereafter outputs the generated screen data to the client terminal 7.

The client terminal 7 is a general-purpose communication terminal device comprising information processing resources such as a CPU, a memory and a hard disk device, as well as a display device such as a liquid crystal display. The client terminal 7 displays the foregoing water leakage monitoring screen based on the screen data transmitted from the water leakage monitoring server 6.

### (2) Sensor Data, etc. Collection Method in This Water Leakage Monitoring System

The method adopted by the water leakage monitoring system 1 for collecting the sensor data, etc. acquired by each water leakage sensor 2 (this is hereinafter referred to as the “sensor data, etc. collection method” in this embodiment) is now explained.

With the water leakage monitoring system 1, vehicles that travel along a predetermined path, such as a bus, a postal truck or a parcel delivery truck, are used as the travel vehicle 3. The receiver 4 is mounted on each of these travel vehicles 3, and the receiver 4 collects the sensor data, etc. from each water leakage sensor 2 position on the travel route of the travel vehicles 3.

Moreover, the sensor data, etc. acquired by a water leakage sensor 2 not positioned on the travel route of any of the travel vehicles 3 is transmitted, via the multihop wireless communication method, to one of the water leakage sensors 2 positioned on the travel route of one of the travel vehicles 3, and collected by the receiver 4 via such water leakage sensor 2.

However, with the conventional multihop wireless communication method, each communication terminal, as a repeater, transmits information based on the relay method, and information is ultimately aggregated in one communication terminal. Thus, if such conventional multihop wireless communication method is directly applied to the water leakage monitoring system 1 of the present invention, the sensor data, etc. of each water leakage sensor 2 not positioned on the travel route of the travel vehicle 3 will be aggregated in one of the water leakage sensors 2 positioned on the travel route of one of the travel vehicles 3.

Nevertheless, if all sensor data, etc. are aggregated in one water leakage sensor 2, considerable power will be consumed for that water leakage sensor 2 to transmit such sensor data, etc. to the receiver 4, and there is a problem in that the battery 14 of that water leakage sensor 2 will be consumed quicker by that much.

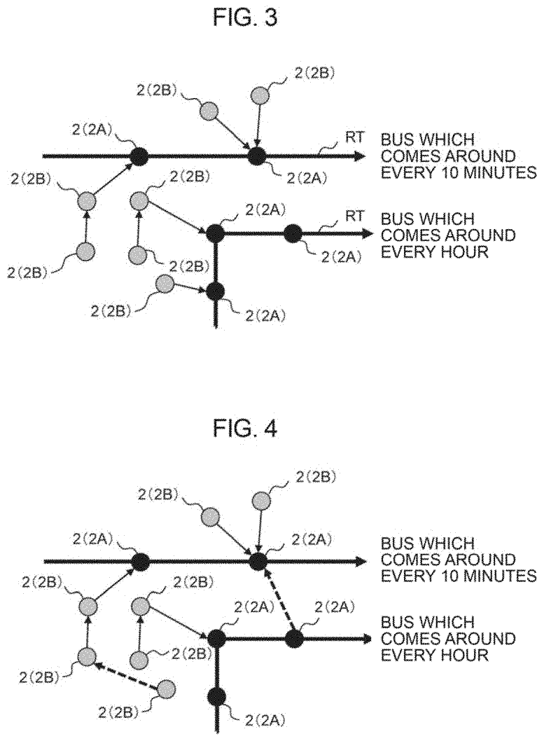

Thus, with the water leakage monitoring system 1 of the present invention, as shown in FIG. 3, with regard to each water leakage sensor 2 (2B) not positioned on the travel route RT of any of the travel vehicles 3, the water leakage sensors 2 (2A, 2B) of a subsequent stage in the multihop wireless communication are respectively preset so that the sensor data, etc. is evenly distributed and aggregated in each water leakage sensor 2 (2A) positioned on the travel route RT of any of the travel vehicles 3. It is thereby possible to prevent the sensor data, etc. of all water leakage sensors 2 (2B) not positioned on the travel route RT of any of the travel vehicles 3 from being aggregated in one water leakage sensor 2 (2A).

Meanwhile, the service interval of the travel vehicles 3 varies depending on the type of travel vehicle 3 such as a bus, a postal truck or a parcel delivery truck, and, even with the same type of travel vehicle 3, the service interval will vary depending on the travel route RT. For example, among the travel routes of a bus, there may be a route in which a bus makes a round every 10 minutes, and there may be a route in which a bus makes a round only once every hour.

Thus, if a transmission destination of the sensor data, etc. of each water leakage sensor 2 (2B) not positioned on the travel route TR of any of the travel vehicles 3 (water leakage sensors 2 of a subsequent stage in the multihop wireless communication) is decided in a fixed manner as described above, even if a water leakage sensor 2 (2B) detects an abnormality in the abnormal value determination, there may be cases where the detection result cannot be promptly conveyed to the monitoring system 5.

For example, even if a water leakage sensor 2 (2B), which has been set to aggregate the sensor data, etc. of the water leakage sensors 2 (2A) on the travel route RT in which a bus makes a round only once every hour, detects an abnormality, since the detection result may not be collected by the receiver 4 for up one hour, the monitoring system 5 is unable to recognize the occurrence of an abnormality during that period.

Thus, as shown in FIG. 4, when a water leakage sensor 2 (2B) not positioned on the travel route RT of any of the travel vehicles 3 obtains a result of an abnormality in the abnormal value determination of the sensor data, the water leakage monitoring system 1 of the present invention is equipped with a routing switching function of switching the water leakage sensor 2 of a subsequent stage in the multihop wireless communication to one of the water leakage sensors 2 (2A, 26) in a multihop network which aggregates the sensor data, etc. in a water leakage sensor 2 (2A) on the travel route RT having a higher travel frequency of the travel vehicle 3 than the travel route RT on which the water leakage sensor 2 (2A) of the previous aggregation destination is positioned.

For example, when a water leakage sensor 2 (2A) positioned on the travel route RT in which the travel vehicle 3 makes a round only once every hour, or when a water leakage sensor 2 (2B) set so as to aggregate the sensor data, etc. in such water leakage sensor 2 (2A), detects an abnormality in the abnormal value determination of the sensor data, the water leakage sensor 2 of a subsequent state in the multihop wireless communication is switched so that the sensor data, etc. is transmitted to one of the water leakage sensor 2 (2A, 2B) in the multihop network which aggregates the sensor data, etc. in the water leakage sensor 2 (2A) positioned on the travel route RT in which the travel vehicle 3 makes a round every 10 minutes (dashed arrow in FIG. 4).

Meanwhile, with the water leakage monitoring system 1 of this embodiment configured as described above, since the capacity of the battery 14 that can be mounted on each water leakage sensor 2 is not great, power saving of the water leakage sensor 2 is demanded. Thus, conventionally, the water leakage sensor 2 was configured to activate at a designated time, or a method of transmitting an activation command from the receiver 4, at the time that the travel vehicle 3 approaches the water leakage sensor 2, and activating that water leakage sensor 2 was adopted.

Nevertheless, according to the former method, there is a problem in that the sensor data, etc. cannot be collected from the water leakage sensor 2 if the travel vehicle 3 does not pass through such water leakage sensor 2 at the designated time due to traffic or other reasons, and according to the latter method, the water leakage sensor 2 needs to be suddenly activated after receiving the activation command from the receiver 4, and there is a problem in that the power consumption will be significant.

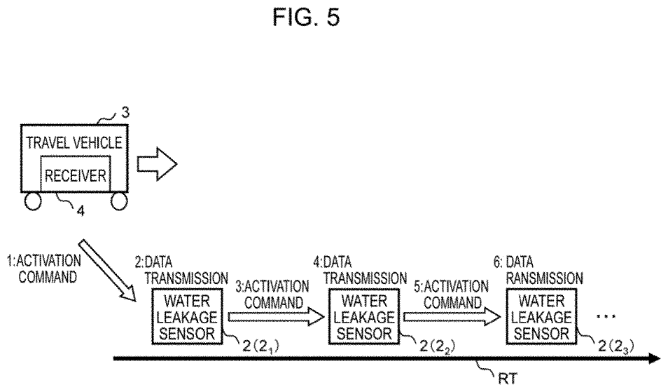

Thus, with the water leakage monitoring system 1 of this embodiment, as shown in FIG. 5, each water leakage sensor 2 positioned on the travel route RT of the travel vehicle 3 activates the next water leakage sensor 2 after transmitting the sensor data, etc. to the receiver 4 of that travel vehicle 3, and thereafter switches to a power saving mode in which unneeded functions are turned off.

Specifically, with the water leakage monitoring system 1 of the present invention, when the travel vehicle 3 enters a predetermined range of the first water leakage sensor 2 (2₁) positioned on the travel route RT, the receiver 4 mounted on that travel vehicle 3 transmits an activation command to the water leakage sensor 2 (2₁) and thereby activates that water leakage sensor 2.

Subsequently, the first water leakage sensor 2 (2₁) activated by the receiver 4 transmits its own sensor data, etc. to the receiver 4, thereafter transmits an activation command to the next water leakage sensor 2 (2₂) positioned on the travel route RT and activates that water leakage sensor 2 (2₂), and then switches to a power saving mode.

Moreover, each water leakage sensor 2 (2₂, . . . ) of the second water leakage sensor 2 onward positioned on the travel route RT transmits its own sensor data, etc. to the receiver 4 in the same manner as the first water leakage sensor 2 (2₁) when it is activated by the preceding water leakage sensor 2 (2₁, 2₂, . . . ) positioned on the travel route RT, thereafter transmits an activation command to the next water leakage sensor 2 (2₃, . . . ) positioned on the travel route RT and activates that water leakage sensor 2 (2₃, . . . ), and thereafter returns to a power saving mode.

Consequently, with the water leakage monitoring system 1 of the present invention, the water leakage sensors 2 (2₁, 2₂, 2₃, . . . ) capable of communicating with the receiver 4 mounted in the travel vehicle 3 are sequentially activated pursuant to such travel vehicle 3 traveling along the travel route RT, and the receiver 4 mounted on that travel vehicle 3 can collect the sensor data, etc. from these water leakage sensors 2 without having to suddenly activate each water leakage sensor 2 positioned on the travel route RT of the travel vehicle 3.

As means for realizing this kind of sensor data, etc. collection method according to this embodiment, the memory 11 of each water leakage sensor 2 stores, as shown in FIG. 2, a control program 15, a sensor data table 16, a routing table 17 and an activation command target sensor table 18.

The control program 15 is a program with a function of causing the CPU 12 (FIG. 2) of the water leakage sensor 2 to execute processing such as the abnormal value determination of the sensor data described above, transmission of the sensor data, etc. based on multihop wireless communication and switching of the transmission destination thereof, and activation of the next water leakage sensor 2 positioned on the travel route RT.

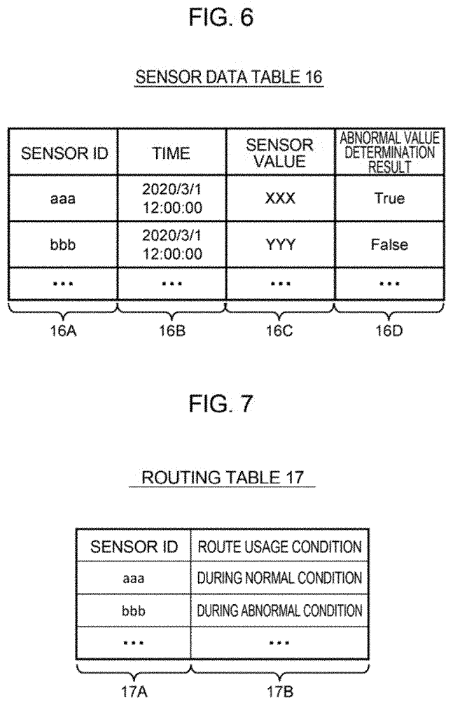

Moreover, the sensor data table 16 is a table that is used for storing and retaining the sensor data output from the vibration sensor 10 (FIG. 2) of its own water leakage sensor 2 and the abnormal value determination result of such sensor data, and the sensor data, etc. transmitted from the water leakage sensor 2 of a preceding stage in the multihop wireless communication. The sensor data table 16 is configured by comprising, as shown in FIG. 6, a sensor ID column 16A, a time column 16B, a sensor value column 16C and an abnormal value determination result column 16D. In the sensor data table 16, one line corresponds to one sensor data.

The sensor ID column 16A stores an identifier (sensor ID) which has been assigned to the water leakage 2 that acquired the corresponding sensor data, and which is unique to that water leakage sensor 2. Moreover, the time column 16B stores the date and time that the water leakage sensor 2 acquired the sensor data, and the sensor value column 16C stores the value of the sensor data.

Furthermore, the abnormal value determination result column 16D stores the determination result of the abnormal value determination of the sensor data. FIG. 6 shows an example where “True” is stored when an abnormality was not detected based on the abnormal value determination, and “False” is stored when an abnormality was detected based on the abnormal value determination.

Accordingly, the example of FIG. 6 shows a case where the water leakage sensor having a sensor ID of “aaa” acquired sensor data having a value of “xxx” on “2020 Mar. 1 12:00:00”, and the data value thereof is normal (“True”).

The routing table 17 is a table storing the respective transmission destinations of the sensor data, etc. (water leakage sensors 2 of a subsequent stage in the multihop wireless communication), which have been preset in the water leakage sensors 2, during an abnormal condition in which an abnormal value is detected in the abnormal value determination and during a normal condition in which an abnormal value was not detected in the abnormal value determination, and is configured by comprising, as shown in FIG. 7, a sensor ID column 17A and a route usage condition column 17B.

The sensor ID column 17A stores the sensor ID of the water leakage sensor 2 to become the transmission destination of the sensor data, etc., and the route usage condition column 17B stores the condition (normal condition or abnormal condition) in which the sensor data should be transmitted to the water leakage sensor 2.

Accordingly, the example of FIG. 7 shows a setting in which, with regard to the water leakage sensor 2 retaining that routing table 17, the sensor data, etc. transmitted from the water leakage sensor 2 of a preceding stage in the multihop wireless communication and its own sensor data, etc. should be transmitted to the water leakage sensor 2 having a sensor ID of “aaa” during a “normal condition”, and transmitted to the water leakage sensor 2 having a sensor ID of “bbb” during an “abnormal condition”.

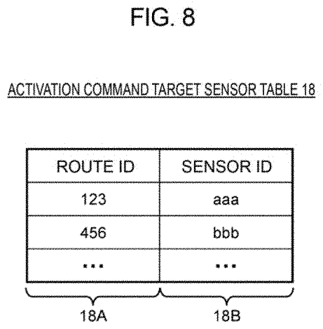

The activation command target sensor table 18 is a table that is used by the water leakage sensor 2 retaining such activation command target sensor table 18 for managing the next water leakage sensor 2 to be activated after transmitting the sensor data, etc. to the receiver 4 mounted on the travel vehicle 3. The activation command target sensor table 18 is configured by comprising, as shown in FIG. 8, a route ID column 18A and a sensor ID column 18B. In the activation command target sensor table 18, one line corresponds to one water leakage sensor 2 to be activated by the water leakage sensor 2 retaining such activation command target sensor table 18.

The route ID column 18A stores the sensor ID of the water leakage sensor 2 to be activated by the water leakage sensor 2 retaining such activation command target sensor table 18, and the route ID column 18B stores an identifier (route ID) which has been assigned to the travel route RT (FIG. 5) on which the water leakage sensor (water leakage sensor to be activated) 2 is positioned, and which is unique to that travel route RT.

Accordingly, in the example of FIG. 8, when the travel vehicle 3 equipped with the receiver 4 that transmitted the sensor data, etc. is a travel vehicle that is traveling along the travel route RT having a route ID of “123”, the sensor ID of the next water leakage sensor 2 to be activated after transmitting the sensor data, etc. to the receiver 4 is “aaa”, and, when the travel vehicle 3 is a travel vehicle that is traveling along the travel route having a route ID of “456”, the sensor ID of the next water leakage sensor 2 to be activated after transmitting the sensor data, etc. to the receiver 4 is “bbb”.

By way of reference, the reason why a plurality of sensor IDs are registered in the activation command target sensor table 18 as shown in FIG. 8 is because the water leakage sensor 2 retaining this activation command target sensor table 18 is positioned on a common part on the travel route RT of a plurality of travel vehicles 3. Accordingly, only one sensor ID is registered in the activation command target sensor table 18 of the water leakage sensor 2 positioned on a route part of a certain travel route RT that is not common with another travel route RT.

Moreover, in the case of this embodiment, when the receiver 4 communicates with the water leakage sensor 2, the receiver 4 notifies the water leakage sensor 2 of the route ID of the travel route RT of the travel vehicle 3 on which it is mounted. Furthermore, each water leakage sensor 2 transmits an activation command including such route ID to the next water leakage sensor 2. Consequently, even when the water leakage sensor 2 is positioned on a common part of the travel route RT of a plurality of travel vehicles 3, the water leakage sensor 2 to be activated next can be identified based on the route ID included in the activation command.

### (3) Various Types of Processing Related to Sensor Data, etc. Collection Method According to This Embodiment

The various types of processing executed in the water leakage sensor 2 in relation to the sensor data, etc. collection method according to this embodiment described above is now explained. Note that, while the processing subject of the various types of processing is explained as the “control program 15” in the following explanation, in effect, it goes without saying that the CPU 12 (FIG. 1) executes the processing based on the control program 15 (FIG. 1).

### (3-1) Multihop Data Transmission Processing

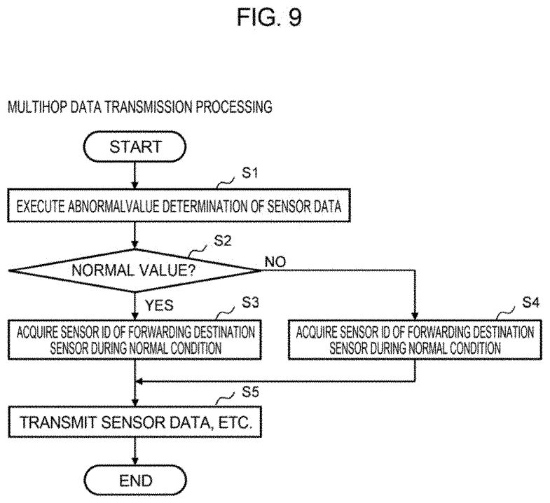

FIG. 9 shows the processing routine of the multihop data transmission processing that is executed at a constant frequency based on the control program 15 of the water leakage sensor 2. The control program 15, according to the processing routine shown in FIG. 9, transmits the sensor data, etc., which was transmitted from the water leakage sensor of a preceding stage in the multihop wireless communication, and its own sensor data, etc., to the water leakage sensor 2 of a subsequent stage in the multihop wireless communication.

In effect, when the control program 15 starts the multihop data transmission processing, the control program 15 foremost executes the abnormal value determination to the sensor data acquired from the vibration sensor 10 (FIG. 2) in its own water leakage sensor 2 (S1), and determines whether the value of that sensor data is a normal value (S2).

When the control program 15 obtains a positive result in the foregoing determination, the control program 15 acquires, from the routing table 17 (FIG. 7), a sensor ID of the water leakage sensor 2 to be used as the transmission destination of the sensor data, etc. during a normal condition (S3). Moreover, when the control program 15 obtains a negative result in step S2, the control program 15 acquires, from the routing table 17 (FIG. 7), a sensor ID of the water leakage sensor 2 to be used as the transmission destination of the sensor data, etc. during an abnormal condition (S4).

Next, the control program 15 reads, from the sensor data table 16, the sensor data, etc. transmitted from the water leakage sensor 2 of a preceding stage in the multihop wireless communication, the sensor data acquired from the vibration sensor 10 in its own water leakage sensor 2, and the determination result of the abnormal value determination of step S1, and transmits these to the water leakage sensor 2 of the sensor ID acquired in step S3 or step S4 (S5). The control program 15 thereafter ends the multihop data transmission processing.

### (3-2) Water Leakage Sensor Activation Processing

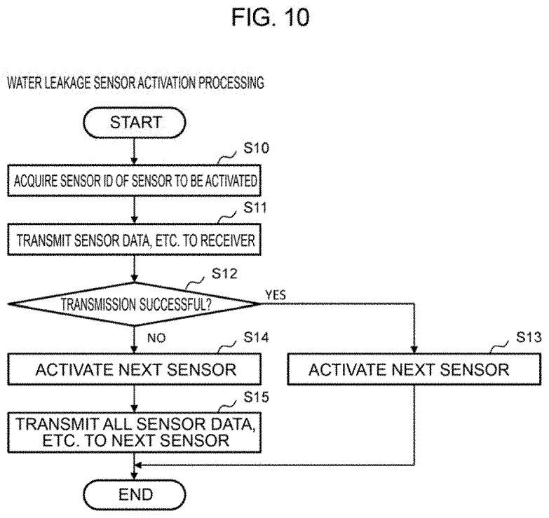

Meanwhile, FIG. 10 shows the processing routine of the water leakage sensor activation processing to be executed by the receiver 4 mounted on the travel vehicle 3 or the water leakage sensor 2 activated by the previous water leakage sensor 2 on the travel route RT of that travel vehicle 3. The control program 15, according to the processing routine shown in FIG. 10, activates the next water leakage sensor 2 on the travel route RT to which the travel vehicle 3 will approach next.

In effect, when the control program 15 receives an activation command from the receiver 4 or another water leakage sensor 2, the control program 15 starts the water leakage sensor activation processing shown in FIG. 10, and foremost acquires, from the activation command target sensor table 18 (FIG. 8), a sensor ID of the water leakage sensor 2 to be activated by its own water leakage sensor 2 (S10).

Specifically, the control program 15, with the route ID included in the received activation command as the search word, reads the sensor ID stored in the sensor ID column 18B of the line in which the route ID in the activation command target sensor table 18 is stored in the route ID column 18A.

Next, the control program 15 reads all necessary sensor data and their abnormal value determination results registered in the sensor data table 16 (FIG. 6), and transmits these to the receiver 4 to become the unit at the other end of the communication (S11).

Next, the control program 15 determines whether the transmission of such sensor data, etc. to the receiver 4 was successful (S12). When the control program 15 obtains a positive result in the foregoing determination, the control program transmits an activation command to the water leakage sensor 2 of the sensor ID acquired in step S10 and thereby activates that water leakage sensor 2 (S13), and then ends the water leakage sensor activation processing.

Meanwhile, when the control program 15 obtains a negative result in the determination of step S12, the control program 15 activates the next water leakage sensor 2 in the same manner as step S13 (S14), and transmits all sensor data, etc., in which the transmission thereof to the receiver 4 in step S12 was unsuccessful, to that water leakage sensor 2 (S15). The control program 15 thereafter ends the water leakage sensor activation processing.

Note that the water leakage sensor 2 activated in step S14 registers the sensor data, etc. transmitted in step S15 in its own sensor data table 16, and thereafter transmits such sensor data, etc., together with the sensor data, etc. originally registered in the sensor data table 16, to the receiver 4 to become the unit at the other end of the communication. The sensor data, etc., in which the transmission thereof to the receiver 4 in step S12 was unsuccessful, is thereby transmitted by the next water leakage sensor 2 to the receiver 4.

### (4) Effect of This Embodiment

As described above, with the water leakage monitoring system 1 of this embodiment, the sensor data of a water leakage sensor 2 not positioned on the travel route RT of the travel vehicle 3, and the determination result of the abnormal value determination of such sensor data, are aggregated in a water leakage sensor 2 positioned on the travel route RT of the travel vehicle 3. Thus, according to the water leakage monitoring system 1 of the present invention, the sensor data of water leakage sensors 2 installed at locations where the travel vehicle 3 cannot pass through, and the determination result of the abnormal value determination of such sensor data, can be reliably collected.

Moreover, with the water leakage monitoring system 1 of the present invention, when a water leakage sensor 2 not positioned on the travel route RT of any of the travel vehicles 3 obtains a result of an abnormality in the abnormal value determination of the sensor data, since the water leakage sensor 2 of a subsequent stage in the multihop wireless communication is switched to one of the water leakage sensors 2 in a multihop network which aggregates the sensor data, etc. in a water leakage sensor 2 on the travel route RT having a higher travel frequency of the travel vehicle than the travel route RT on which the water leakage sensor 2 of the previous aggregation destination is positioned, the foregoing determination result of the abnormal value determination can be promptly collected and conveyed to the water leakage monitoring server 6.

Thus, according to the water leakage monitoring system 1 of the present invention, it is possible to realize an information collection system capable of reliably collecting sensor data and the determination result of the abnormal value determination of such sensor data even from water leakage sensors 2 installed at locations where a travel vehicle 3 cannot pass through, and also promptly collecting information of urgent nature.

### (5) Other Embodiments

Note that, while the foregoing embodiment explained a case where the present invention is applied to the water leakage monitoring system 1 which monitors water leakage of a water pipe, the present invention is not limited thereto, and, for example, the present invention can also be broadly applied to various types of information collection systems which collect information from a plurality of sensors installed in various structures, such as equipment installed on a gas pipe or a utility pole.

Moreover, while the foregoing embodiment explained a case of aggregating and collecting both the sensor data of each water leakage sensor 2 and the determination result of the abnormal value determination of such sensor data in a predetermined water leakage sensor 2 based on the multihop wireless communication method, the present invention is not limited thereto, and the present invention can also be applied to cases where only one of either the sensor data or the determination result of the abnormal value determination of such sensor data is aggregated and collected in a predetermined water leakage sensor 2 based on the multihop wireless communication method.

Furthermore, while the foregoing embodiment explained a case where the water leakage sensors 2 of a subsequent stage in the multihop wireless communication are respectively preset so that the sensor data, etc. is evenly distributed and aggregated in each water leakage sensor 2 positioned on the travel route RT of any of the travel vehicles 3, the present invention is not limited thereto, and the sensor data, etc. may also be unevenly distributed and aggregated in each water leakage sensor 2 positioned on the travel route RT of any of the travel vehicles 3.

In addition, while the foregoing embodiment explained a case where each water leakage sensor 2 on the travel route RT of the travel vehicle 3 activates the next water leakage sensor 2 after transmitting the sensor data, etc. to the receiver 4, the present invention is not limited thereto, and the sensor data, etc. may be transmitted to the receiver 4 after the next water leakage sensor 2 is activated.

### INDUSTRIAL APPLICABILITY

The present invention can be broadly applied to various types of information collection systems which collect sensor data from a plurality of sensors installed in a structure and the abnormal value determination result of such sensor data.

### REFERENCE SIGNS LIST

1 . . . water leakage monitoring system, 2, 2A, 2B, 2₁ to 2₃ . . . water leakage sensor, 3 . . . travel vehicle, 4 . . . receiver, 5 . . . monitoring system, 12 . . . CPU, 13 . . . transmitter, 15 . . . control program, 16 . . . sensor data table, 17 . . . routing table, 18 . . . activation command target sensor table, RT . . . travel route.

1. An information collection system, comprising:
a plurality of sensors installed in a structure, wherewith each of the plurality of sensors sequentially transmits sensor data and/or an abnormal value determination result of the sensor data based on a multihop wireless communication method; and
a receiver, which is mounted on a travel vehicle that travels along a given route, which receives the sensor data transmitted from the sensors positioned on the route,
wherein:
each of the sensors not positioned on the route travelled by the travel vehicle transmits, to the sensors of a subsequent stage in multihop wireless communication preset so that the sensor data and/or the abnormal value determination result is aggregated in a predetermined sensor positioned on the route travelled by the travel vehicle, the sensor data and/or the abnormal value determination result transmitted from the sensors of a preceding stage in the multihop wireless communication, as well as its own sensor data and abnormal value determination result;
the sensor positioned on the route travelled by the travel vehicle transmits the aggregated sensor data and/or abnormal value determination result to the receiver; and
during an abnormal condition where an abnormality is detected in the abnormal value determination, each of the sensors not positioned on the route travelled by the travel vehicle switches a transmission destination of the sensor data and/or the abnormal value determination result to one of the sensors in a multihop network which aggregates the sensor data and/or the abnormal value determination result in the sensor positioned on the route having a higher travel frequency of the travel vehicle than the route on which the sensor of an aggregation destination of the sensor data and/or the abnormal value determination result is positioned during a normal condition where an abnormality is not detected in the abnormal value determination.

2. The information collection system according to claim 1,
wherein the sensors of a subsequent stage in the multihop wireless communication of each of the sensors not positioned on the route travelled by the travel vehicle are respectively set so that the sensor data and/or the abnormal value determination result from each of the sensors not positioned on the route travelled by the travel vehicle is evenly distributed and aggregated in each of the sensors positioned on the route travelled by the travel vehicle.

3. The information collection system according to claim 1,
wherein the sensor positioned on the route travelled by the travel vehicle, after transmitting its own sensor data and/or abnormal value determination result to the receiver, activates the next sensor on the route travelled by the travel vehicle.

4. The information collection system according to claim 3,
wherein the sensor positioned on the route travelled by the travel vehicle, after activating the next sensor on the route travelled by the travel vehicle, switches to a power saving mode.

5. The information collection system according to claim 3,
wherein, when the sensor positioned on the route travelled by the travel vehicle is unsuccessful in transmitting its own sensor data and/or abnormal value determination result to the receiver, the sensor activates the next sensor on the route travelled by the travel vehicle, and thereafter transmits the sensor data and/or the abnormal value determination result, in which the transmission thereof was unsuccessful, among its own sensor data and/or abnormal value determination result to the next sensor on the route travelled by the travel vehicle.

6. An information collection method to be executed in an information collection system which collects sensor data and/or an abnormal value determination result of the sensor data from a plurality of sensors installed in a structure,
wherein:
the information collection system includes a receiver, which is mounted on a travel vehicle that travels along a given route, which receives the sensor data transmitted from the sensors positioned on the route;
the information collection method comprises:
a first step of each of the sensors not positioned on the route travelled by the travel vehicle transmitting, to the sensors of a subsequent stage in multihop wireless communication preset so that the sensor data and/or the abnormal value determination result is aggregated in a predetermined sensor positioned on the route travelled by the travel vehicle, the sensor data and/or the abnormal value determination result transmitted from the sensors of a preceding stage in the multihop wireless communication, as well as its own sensor data and abnormal value determination result; and
a second step of the sensor positioned on the route travelled by the travel vehicle transmitting the aggregated sensor data and/or abnormal value determination result to the receiver; and
in the first step, during an abnormal condition where an abnormality is detected in the abnormal value determination, each of the sensors not positioned on the route travelled by the travel vehicle switches a transmission destination of the sensor data and/or the abnormal value determination result to one of the sensors in a multihop network which aggregates the sensor data and/or the abnormal value determination result in the sensor positioned on the route having a higher travel frequency of the travel vehicle than the route on which the sensor of an aggregation destination of the sensor data and/or the abnormal value determination result is positioned during a normal condition where an abnormality is not detected in the abnormal value determination.

7. The information collection method according to claim 6,
wherein the sensors of a subsequent stage in the multihop wireless communication of each of the sensors not positioned on the route travelled by the travel vehicle are respectively set so that the sensor data and/or the abnormal value determination result from each of the sensors not positioned on the route travelled by the travel vehicle is evenly distributed and aggregated in each of the sensors positioned on the route travelled by the travel vehicle.

8. The information collection method according to claim 6, further comprising:
a third step of the sensor positioned on the route travelled by the travel vehicle, after transmitting its own sensor data and/or abnormal value determination result to the receiver, activating the next sensor on the route travelled by the travel vehicle.

9. The information collection method according to claim 8, further comprising:
a fourth step of the sensor positioned on the route travelled by the travel vehicle, after activating the next sensor on the route travelled by the travel vehicle, switching to a power saving mode.

10. The information collection method according to claim 8,
wherein, in the third step, when the sensor positioned on the route travelled by the travel vehicle is unsuccessful in transmitting its own sensor data and/or abnormal value determination result to the receiver, the sensor activates the next sensor on the route travelled by the travel vehicle, and thereafter transmits the sensor data and/or the abnormal value determination result, in which the transmission thereof was unsuccessful, among its own sensor data and/or abnormal value determination result to the next sensor on the route travelled by the travel vehicle.
